(19) United States
(12) Patent Application Publication
(10) Pub. No.: US 2008/0110713 A1
(43) Pub. Date: May 15, 2008

(54) Gravity biased constant response pantograph

(75) Inventor: Brian Laird Fisher, Ontario (CA)

Correspondence Address: BRADLEY ARANT ROSE & WHITE, LLP;INTELLECTUAL PROPERTY DEPARTMENT-NWJ, 1819 FIFTH AVENUE NORTH, BIRMINGHAM, AL, 35203-2104, US

(73) Assignee: Mining Technologies International (MTI)

(21) Appl. No.: 11/595,420

(22) Filed: Nov. 10, 2006

(51) Int. Cl. B60L 5/12

(52) U.S. Cl. 191/64

(57) ABSTRACT

A gravity biased constant response pantograph is disclosed. A counterweight is used to lift a collector towards an overhead conductor. A constraint mechanism constrains movement of the collector to remain substantially vertical thru the entire range of working travel. The counterweight provides a driving force via the force of gravity. A lift mechanism suitable for receiving the driving force drives a travelling assembly upwards towards the overhead conductor. The travelling assembly can be realized combining various types of collectors and masts. The counterweight is provided in two portions to accommodate various combinations of masts and collectors. By further trimming the weight of the counterweight, the amount of constant response force acting on the travelling assembly can be precisely pre-determined to be substantially constant throughout the entire range of travel of the travelling assembly.

### CROSS-REFERENCE TO RELATED APPLICATIONS

This is the first application filed for the present invention.

### MICROFICHE APPENDIX

Not applicable.

### TECHNICAL FIELD

This application relates to trolley collector stands in general, and to gravity biased constant response pantographs, in particular.

### BACKGROUND OF THE INVENTION

The term pantograph, originally used to describe a drawing instrument to magnify figures, has taken on the meaning of a device to collect current from an overhead conductor to power electric trains or other vehicles. It is in this latter sense that the term is used herein.

Although various pantograph designs are well known, there is a need to teach design and functional requirements desired of such devices on one hand, and a need for a pantograph which meets these desired design and functional requirements and which incorporates all required functional criteria on the other hand.

Information relevant to attempts to address these problems can be found in Canadian Patent Nos. 974,309, 2,189,409, and in U.S. Pat. Nos. 5,531,301, 5,566,800, and 1,364,672. However, each of these references suffers from one or more of the following disadvantages:
1) the vertically applied force and/or travel velocity of collector to conductor may not be constant thru the entire range of working travel;
2) force adjustment required for optimizing performance of each application's dynamic conditions may not be applied in increments and may not provide predictable response;
3) the mechanism design may not eliminate the possibility of dynamic excitation of individual integrated components that would create force variability;
4) the mechanism may not have low system hysteresis;
5) the collector design may not provide a reliable non-disruptive current path, from brush(es) to motor controller, thru range of working travel;
6) the electrical separation of housing to collector may not require an element of high dielectric strength;
7) the device may not be simple in design and control, and may not require little maintenance;
8) the design may not implement a fail-safe ‘upward mode’; and
9) the device size may not be considered to minimize mounting space requirements.

### SUMMARY

According to one aspect of the present invention, there is provided: a pantograph suitable for enabling a vehicle to engage an overhead conductor, the pantograph comprising: (a) a travelling assembly having a main axis; (b) a travelling assembly constraint mechanism suitable for constraining movement of said travelling assembly so that the main axis of said travelling assembly remains substantially vertical thru the entire range of working travel of the travelling assembly; (c) a driving force generation mechanism, said driving force generation mechanism suitable for generating a driving force, said driving force generation mechanism comprising a counterweight so that the driving force comprises the force of gravity acting on said counterweight; and (d) a lift mechanism suitable for receiving the driving force of said driving force generation mechanism, said lift mechanism suitable for driving said travelling assembly along the main axis of said travelling assembly by applying a lift force onto said mast which is derived from at least a portion of the driving force.

According to another aspect of the present invention, there is provided: a pantograph suitable for engaging an overhead conductor, the pantograph comprising: (a) a support assembly; (b) a collector assembly constrained to move in a substantially vertical fashion; (c) a collector assembly lift mechanism coupling said support assembly to said collector assembly so that a substantially downward vertical force applied onto said collector assembly lift mechanism results in a substantially upwards vertical force being applied to said collector assembly causing said collector assembly to move in a substantially upwards direction relative to said support assembly; and (d) a counterweight driving said collector assembly lift mechanism by gravity to bias said collector assembly in a substantially upwards direction towards the overhead conductor.

According to yet another aspect of the present invention, there is provided: a pantograph suitable for engaging an overhead conductor, the pantograph comprising: (a) a support assembly; (b) a collector assembly constrained to move in a substantially vertical fashion; and (c) a counterweight driving said collector assembly by gravity to bias said collector assembly in a substantially upwards direction towards the overhead conductor; whereby the collector assembly is subject to a substantially constant vertical force throughout the entire working travel of said collector assembly.

Other aspects and features of the present invention will become apparent to those ordinarily skilled in the art upon review of the following description of specific embodiments of a gravity biased constant response pantograph in conjunction with the accompanying drawing figures.

### BRIEF DESCRIPTION OF THE DRAWINGS

Design and functional aspects of a current collecting pantograph provided according to the present invention can be summarized as follows:
1) the vertically applied force and/or travel velocity of collector to conductor must remain a constant thru the entire range of working travel;
2) force adjustment required for optimizing performance of each application's dynamic conditions, must be applied in increments and provide predictable response;
3) the mechanism design must eliminate the possibility of dynamic excitation of individual integrated components that would create force variability;
4) the mechanism mush have low system hysteresis;
5) the collector design must provide a reliable non-disruptive current path, from brush(es) to motor controller, thru range of working travel;
6) the electrical separation of housing to collector requires an element of high dielectric strength;
7) the device must be simple in design and control, requiring little maintenance;
8) the design must implement a fail-safe ‘upward mode’; and
9) the device size must be considered to minimize mounting space requirements.

Embodiments of the present invention will now be described, by way of example only, with reference to the accompanying drawing figures, wherein:

FIG. 1 is a perspective view of one embodiment of a pantograph provided in accordance with the present invention;

Referring now to FIGS. 2-4, FIG. 2 is a top view of the embodiment of a pantograph shown in FIG. 1;

FIG. 3 is a sectional view of the embodiment of a pantograph shown in FIG. 1, taken along section line A-A of FIG. 2;

FIG. 4 is a sectional view of the embodiment of a pantograph shown in FIG. 1, taken along section line B-B of FIG. 2;

FIG. 5 is a free body diagram illustrating forces received by and driven by the lift mechanism of FIGS. 3 and 4; and

FIGS. 6a and 6b illustrate the constant response to variations in height of the conductor above the roadbed during horizontal movement of a pantograph provided according to the present invention.

Like reference numerals are used in different figures to denote similar elements.

### DETAILED DESCRIPTION OF THE DRAWINGS

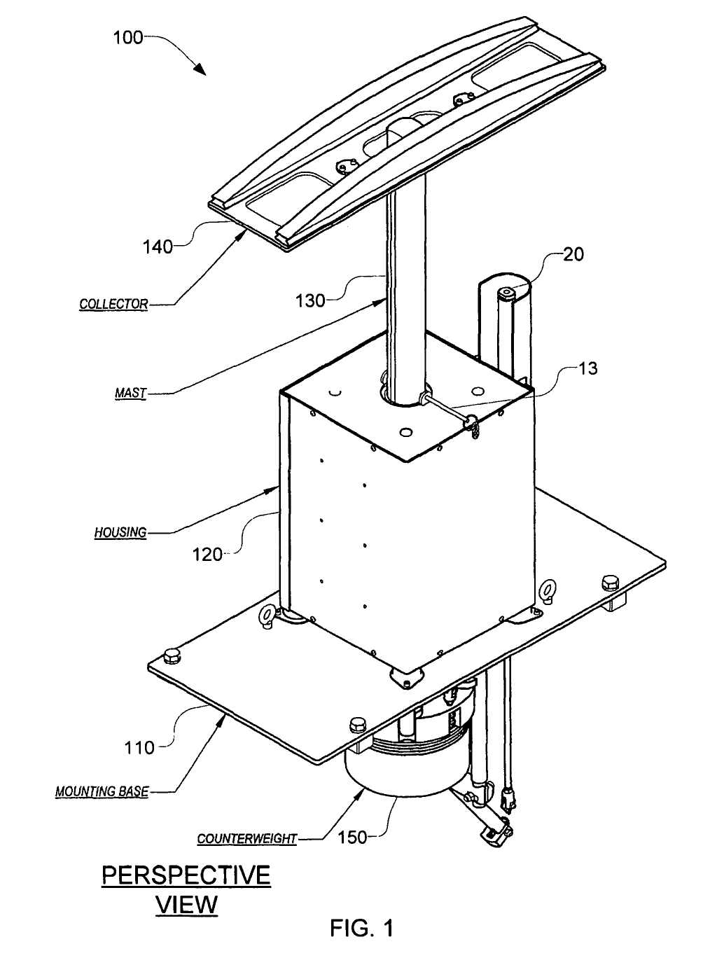

Referring to the drawings, FIG. 1 is a perspective view of one embodiment of a pantograph provided in accordance with the present invention. Pantograph 100 includes a mounting base 110, onto which is supported a housing 120 thru which a mast 130 is gravity biased to displace a collector 140 upwards, the collector 140 affixed at the top end of the mast 130, by action of a counterweight 150 coupled to the mast 130 by a lift mechanism (not shown) within the housing. The pantograph 100 further includes a collector retraction mechanism, including a manual actionable release pin 13 and an automatic retraction cylinder 20. The pantograph 100 can operate in two modes: collector extension mode, and collector retraction mode.

In collector extension mode, the mass of counterweight 150 lifts the mast 130 and the collector 140 via the gravity biasing mechanism, resulting in a vertical force being applied to the overhead conductor. In a preferred embodiment, the lift mechanism is a linear motion device that responds with constant pre-determined force and/or velocity over the entire travel of the mast 130. Advantageously, the pantograph instantaneously responds to ever-changing feed-back from the conductor.

In collector retraction mode, either energizing the retraction cylinder 20 or manually displacing the mast 130, raises the counterweight 150. The mast 130 can remain in a retracted position, either by maintaining the retraction cylinder 20 energized, or by engaging the release pin 13 so as to block movement of the mast 130. De-energizing the retraction cylinder 20 or disengaging the release pin 13 from the mast 130 reverses the process and extends the mast 130 and the retraction cylinder 20.

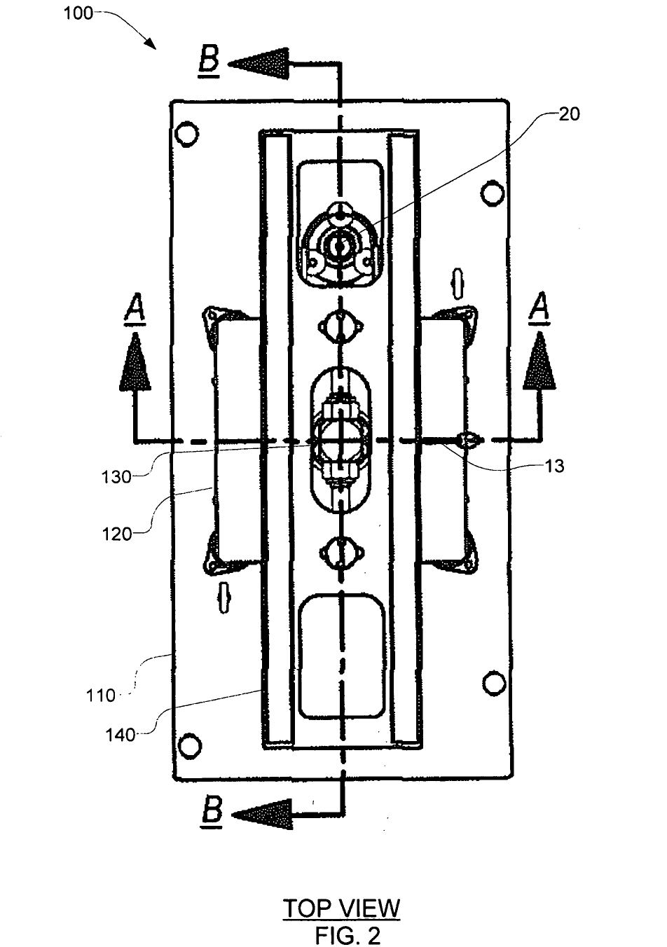

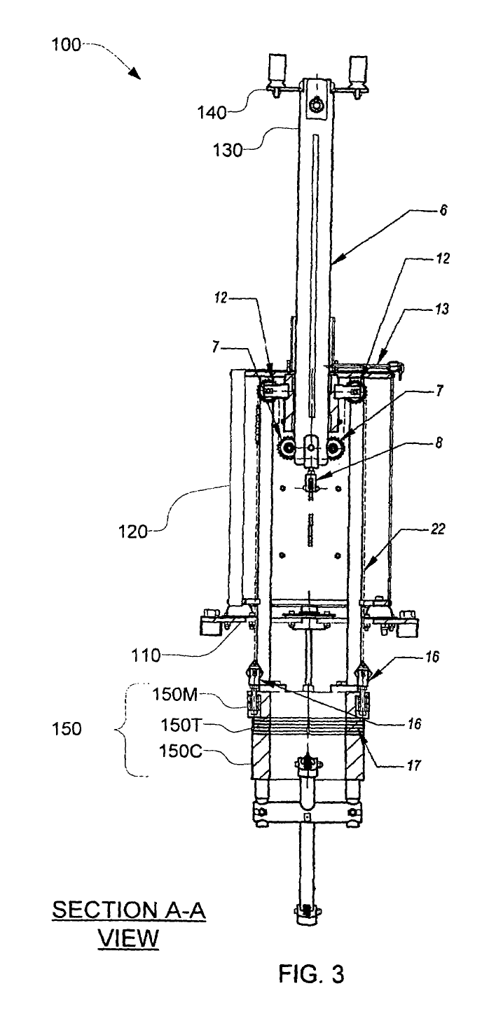

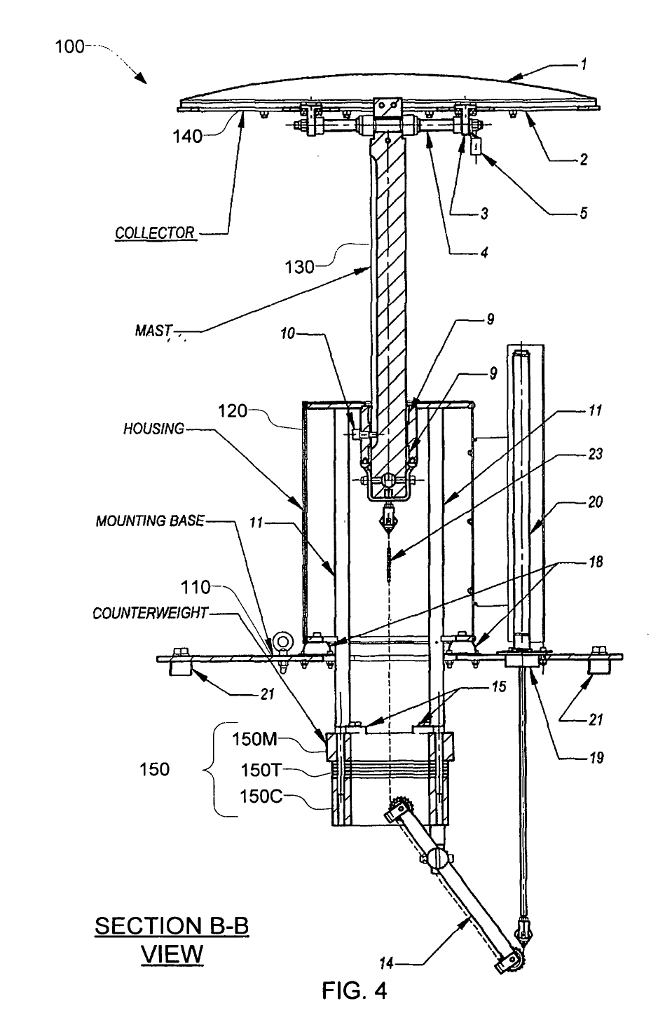

Referring now to FIGS. 2-4, FIG. 2 is a top view of the embodiment of a pantograph shown in FIG. 1. The top view of pantograph 100 features two section lines A-A and B-B corresponding to the A-A sectional view shown in FIG. 3 and the B-B sectional view shown in FIG. 4 respectively. FIG. 3 is a sectional view of the embodiment of a pantograph shown in FIG. 1, taken along section line A-A of FIG. 2. FIG. 4 is a sectional view of the embodiment of a pantograph shown in FIG. 1, taken along section line B-B of FIG. 2.

The mounting base 110 further includes rubber mounts 18 for dynamic nulling, cylinder mount 19 for self aligning, and attachment points 21 whose location can be adjusted depending on the application.

The sectional views of FIGS. 3 and 4 enable further details within housing 120 to be seen. The housing 120 further includes bushings 9 for centric and linear guidance of the mast 130, guide pin 10 for anti-rotational guidance of the mast 130, guide ways 11 for supporting and centric guidance of the counterweight 150, fixed sprockets 12 for supporting the counterweight 150 and the mast 130 thru a lift chain 22, and a chain deflector for routing a retractor chain 23.

The mast 130 further includes an extendable column 6 for supporting the collector 140 and for electrical isolation, travelling sprockets 7 for lifting the mast 130 thru tension of the lift chain 22, and a chain connector 8 for providing a reaction point for a reaction force.

The collector 140 further includes carbon brushes 1 for providing electrical conductive contact with the conductor, a collector base 2 for structural support and providing an electrical load path, a pivot support 3 for allowing oscillation about the mast 130, a spindle 4 for providing connection to mast 130 and a current path to a cable connector 5, and the cable connector 5 for routing current to a motor controller.

The counterweight 150 further includes guide pads 15 for centric guidance of the counterweight 150, chain connectors 16 for providing dynamic nulling and support, and trim weights 17 for providing predictable, incremental force adjustment. The mass of counterweight 150 is advantageously divided into three parts 150A, 150B and 150C in order to facilitate adaptation of the pantograph 100 to any particular application. The first part 150A has a mass which corresponds substantially to the mass of the mast 130 and collector 140. The second part 150C has a mass depends on the truck, locomotive, or vehicle and conductor combination in the application, and serves to adjust the quiet point to which the mast 130 and collector 140 have to extend. The third part 150B of a variable mass which is provided as trim weights 17 so that predictable, incremental force adjustment can be obtained.

In collector extension operation, the effect of gravity on the mass of counterweight 150 lifts the mast 130 and collector 140 thru tension in lift chain 22, applying a vertical pre-determined force to the overhead conductor. The pantograph 100 instantaneously responds to ever-changing feed-back from the conductor by displacing the lift chain 22 about the travelling sprockets 7 and the fixed sprockets 12. The pantograph 100, being a linear motion device, responds with constant force and velocity over the entire travel of the mast 130 and collector 140.

In collector retraction operation, energizing the retraction cylinder 20 displaces the retraction chain 23 about the chain deflector 14, raising the counterweight 150, girdling the lowered mast 130. De-energizing 20, the mast 130 which is counterweight biased reverses the process and extends the retraction cylinder 20 and the mast 130. Manual retraction can be achieved by manual displacement of the retraction chain 23.

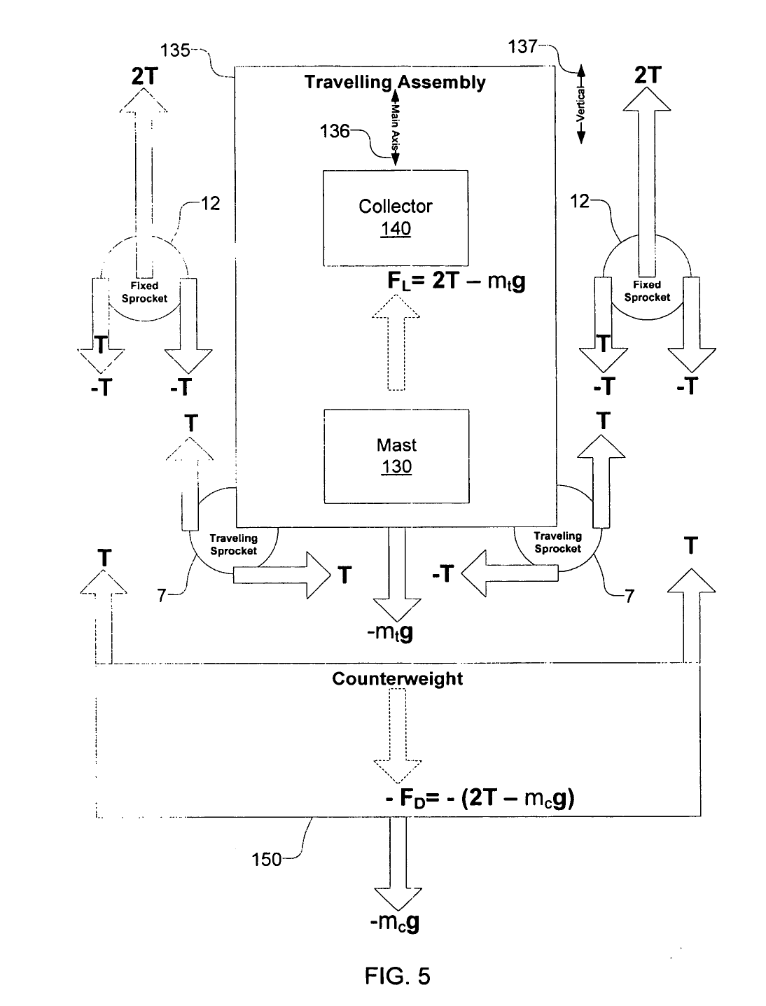

FIG. 5 is a free body diagram illustrating forces received by and driven by the lift mechanism of FIGS. 3 and 4. A pin and a corresponding guide (not shown in FIG. 5) ensure that the travelling assembly 135 is constrained to move along the main axis 136 of the travelling assembly 135 in a substantially vertical 137 fashion, but any other travelling assembly constraint mechanism can be used so long as it is suitable for constraining movement of the travelling assembly so that the main axis of the travelling assembly remains substantially vertical thru the entire range of working travel of the travelling assembly. The free body diagram illustrates how the counterweight provides a constant force response throughout the entire working travel of the pantograph.

First, consider the forces required for the counterweight 150, if treated as a free body. The lift chain 22 (not shown) is attached at either end to the counterweight 156 via chain connectors 16 (not shown in FIG. 5). The lift chain 22 operates under tension T. At each chain connector, an equal and opposite force to the tension in the lift chain 22 T is exerted upwards onto the counterweight 150. The counterweight 150, having a mass m_{c} is subject to the force of gravity −m_{c}g downwards. The resulting force F_{D} is the driving force acting on counterweight 150:

F_{D}=2T−m_{c}g

Next, consider the forces required for each of the fixed sprockets 12 to be in equilibrium. Each fixed sprocket 12 engages the lift chain 16 twice, exerting a tangential force equal and opposite force to the tension lift chain 22, −T exerted downward on either side of each fixed sprocket 12. An equal and opposite reaction force equal to 2T upwards keeps each of the fixed sprocket 12 from moving.

Next, consider the forces acting on the travelling assembly 135. The travelling assembly 135 includes the mast 130, the collector 140, and the two travelling sprockets 7. The tension in the portion of the lift chain 22 which lies between each fixed sprocket 12 and each travelling sprocket 7 results in an equal and opposite force to the tension lift chain 22, T exerted upward onto the travelling assembly 135 at each travelling sprocket 7. Each of the two horizontal forces exerted on the travelling assembly 135 resulting from the tension in the portion of the lift chain 22 which lies between the travelling sprockets 7 are of equal magnitude, T and −T, but are in opposite direction and therefore cancel. The travelling assembly 135, having a mass mₜ is subject to the force of gravity −mₜg downwards. The resulting force F_{L} is the lift force acting on the travelling assembly 135:

F_{L}=2T−mₜg

The lift force can be expressed in terms of the driving force by eliminating the chain tension from the expression:

F_{L}=(F_{D}+m_{c}g)−mₜg=F_{D}+(m_{c}−mₜ)g

Thus, in absence of an external driving force (F_{D}=0), the lift force is constant and proportional to the difference between the travelling assembly 135 mass mₜ and the counterweight 150 mass m_{c}:

F_{L}=(m_{c}−mₜ)g

Advantageously, the lift force can be adjusted by adding trim weights to the counterweight 150. Referring back to FIGS. 3 and 4, the further advantage of breaking up the counterweight 150 into three portions 150M, 150C and 150T can be better appreciated. In one embodiment, the first portion 150M is selected to be of a mass which is substantially equal to the mass of the travelling assembly 135 including mast 130 and travelling sprockets 7, but excluding the mass of the collector 140. The second portion 150C is selected to be substantially equal to the mass of collector 140, so that the combined mass of the first and second portions of the counterweight correspond substantially to at least the mass of the travelling assembly 135, and optionally any additional minimal mass required for a minimal bias, such as to at least raise the mast. Advantageously, this enables combinations of travelling assembly and collectors to be put together in the field so as to adapt the pantograph to the particular requirements of a particular vehicle and conductor application. Each travelling assembly (without collector) can be provided with a corresponding first counterweight portion 150M of substantially at least identical mass to the mass of the travelling assembly (without collector), plus optional additional minimal mass for initial minimal bias. Likewise, each collector could be provided with a corresponding second counterweight portion 150C of substantially identical mass to the mass of the collector. The third portion 150T of the counterweight is provided using trim weights of predetermined mass so that a desired lift can be precisely predetermined to be a constant force throughout the entire travel of the travelling assembly, thereby biasing the pantograph upwards by gravity. The use of trim weights ensures that the lift force can be adjusted, for example, to be appropriate for ensuring proper contact with the overhead conductor without unduly wearing out the brushes 1 of the collector 140.

Depending on the application, the order of the counterweight portions may be interchanged. One advantage of the order shown is that, since the collector 140 has brushes 1 which are more likely to wear out than other components of the travelling assembly 135, the second counterweight 150C corresponding to the collector 140 is positioned at the bottom of counterweight 150 so that it can be easily replace when collector 140 is replaced. Alternatively, the trim weights 150T may be placed at the bottom of counterweight 150 in order to facilitate the adjustment of the lift force.

Advantageously, the collector 140 approaches the overhead conductor under the effect of a constant force F_{L}=(m_{c}−mₜ)g, throughout the range of travel of the collector 140 so that regardless when the collector 130 comes to vertical rest against the overhead conductor, the overhead conductor exerts an equal and opposite constant vertical force (m_{c}−mₜ)g against the collector to bring it to vertical rest, and this independent of the height of the conductor above the roadbed.

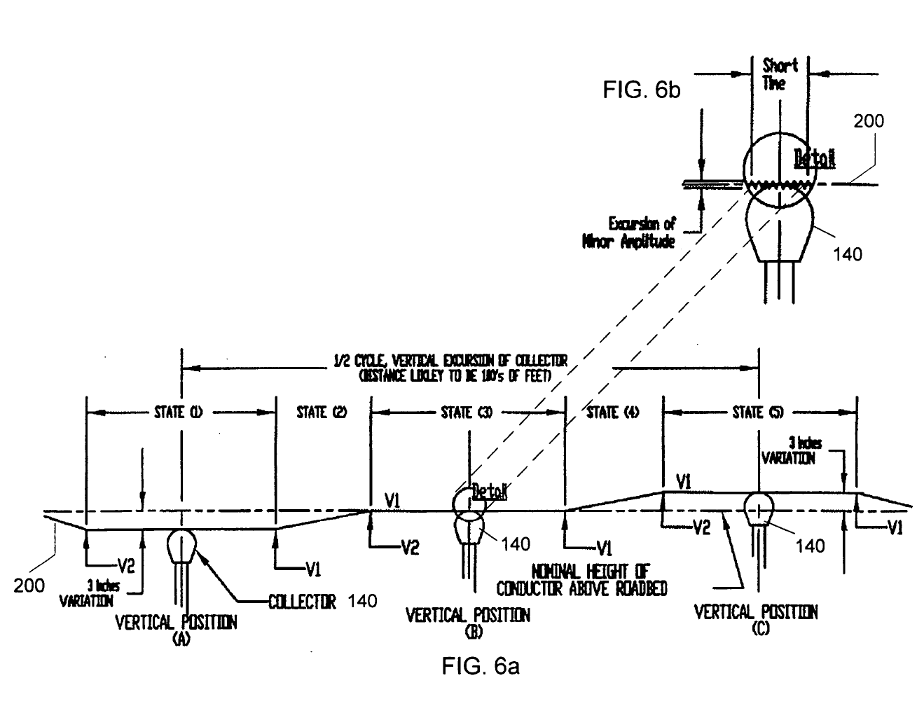

FIGS. 6a and 6b illustrate the constant response to variations in height of the conductor above the roadbed during horizontal movement of a pantograph provided according to the present invention. The collector 140 is shown at three vertical positions A, B, and C as the vehicle travels from left to right on a roadbed which has an overhead collector whose height varies periodically by 6 inches over large distances, such as hundreds of feet. At vertical position A, the collector 140 is substantially at vertical rest against conductor 200, 3 inches below the nominal height of the conductor above the roadbed. At vertical position B, the collector 140 is substantially at vertical rest against conductor 200, at the nominal height above the roadbed. At vertical position C, the collector 140 is substantially at vertical rest against conductor 200, 3 inches above a nominal height above the roadbed.

As the collector moves from vertical position A, to B, and then to C, the collector 140 changes state by constantly responding to variations in the height of the conductor 200 above the roadbed. At vertical position A, B, and C the collector 140 is in state (1), (3), and (5) respectively whereat the vertical position of the collector 140 is substantially constant. FIG. 6b shows in greater detail how conductor 140 constantly responds to small variations of the height of conductor 200 above the roadbed, so that vertical force and velocity are substantially constant (over short periods of time). To get from vertical position A to vertical position B, or from vertical position B to vertical position C, the collector 140 constantly responds to the rate of change of the height of conductor 200 above the roadbed in states (2) and (4) respectively. The transition from positions A, to B, and then to C of collector 140 represent a half cycle of variation of the height of the collector from a nominal height above the roadbed. As the collector moves further past vertical position C, the collector 140 constantly responds to the rate of change of the height of the conductor 200 above the roadbed, and returns to the nominal position of the conductor above the roadbed, and further constantly responds to substantially track the height of the conductor 200 above the roadbed.

In alternative embodiments, the indexed linear drive has multiplication so that adding weight to the counterweight 150 in substantial excess of the weight of the mast 130 and collector 140 results in a multiple of an equal but opposite amount of force biasing the collector 140 towards the conductor by gravity. This can be achieved by using travelling sprockets 7 and fixed sprockets 12 which have different diameters and/or different number of teeth. Using more teeth in one set of sprockets than the other will result in a multiplicative factor. Using the same diameter and number of teeth results in a multiplicative factor of one.

In an alternative embodiments, it is contemplated that the lift chain 22 travelling sprockets 7 and fixed sprockets 12 are substituted with other suitable indexed drive mechanisms which invert the gravitational force provided by the counterweight 150 so as to bias the mast 130 and collector 140 upwards. For example, instead of using chains and sprockets, racks and pinions may be used to invert the gravitational force provided by the counterweight so as to bias the mast 130 and collector 140 upwards.

The above-described embodiments of the present invention are intended to be examples only. Those of skill in the art may effect alterations, modifications and variations to the particular embodiments without departing from the scope of the invention, which is set forth in the claims.

What is claimed is:

1. A pantograph suitable for enabling a vehicle to engage an overhead conductor, the pantograph comprising:
(a) a travelling assembly having a main axis;
(b) a travelling assembly constraint mechanism suitable for constraining movement of said travelling assembly so that the main axis of said travelling assembly remains substantially vertical thru the entire range of working travel of the travelling assembly;
(c) a driving force generation mechanism, said driving force generation mechanism suitable for generating a driving force, said driving force generation mechanism comprising a counterweight so that the driving force comprises the force of gravity acting on said counterweight; and
(d) a lift mechanism suitable for receiving the driving force of said driving force generation mechanism, said lift mechanism suitable for driving said travelling assembly along the main axis of said travelling assembly by applying a lift force onto said travelling assembly which is derived from at least a portion of the driving force.

2. The pantograph as recited in claim 1, wherein the lift force is substantially constant thru the entire range of working travel of the travelling assembly.

3. The pantograph as recited in claim 1, wherein said counterweight comprises a guide pad suitable for centric guidance of said counterweight.

4. The pantograph as recited in claim 1, wherein said counterweight comprises a chain connector suitable for providing at least one of dynamic nulling and support of a lift chain.

5. The pantograph as recited in claim 1, wherein said counterweight comprises at least one trim weight suitable for providing predictable incremental force adjustment.

6. The pantograph as recited in claim 1, wherein the magnitude of the lift force is equal to a multiple of the magnitude of the driving force.

7. The pantograph as recited in claim 6, wherein the multiple is substantially equal to one.

8. The pantograph as recited in claim 6, wherein the multiple is greater than one.

9. The pantograph as recited in claim 6, wherein the multiple is less than one.

10. The pantograph as recited in claim 1, wherein the direction of the lifting force is substantially opposite to the direction of the driving force.

11. The pantograph as recited in claim 1, wherein the lifting force is applied onto said travelling assembly in a direction which is substantially parallel to the main axis of said travelling assembly.

12. The pantograph as recited in claim 1, wherein the driving force is applied onto said lift mechanism in a direction which is substantially parallel to the main axis of said travelling assembly.

13. The pantograph as recited in claim 1, wherein the driving force and the lifting force are substantially parallel to each other.

14. The pantograph as recited in claim 1, wherein said travelling assembly comprises a mast.

15. The pantograph as recited in claim 1, wherein said travelling assembly comprises a collector.

16. The pantograph as recited in claim 1, wherein said travelling assembly comprises a portion of said lift mechanism.

17. The pantograph as recited in claim 1, wherein said travelling assembly comprises a collector suitable for engaging the overhead conductor.

18. The pantograph as recited in claim 17, wherein said collector comprises a carbon brush suitable for providing electrical conductive contact with the conductor.

19. The pantograph as recited in claim 17, wherein said collector comprises a collector base suitable for providing at least one of structural support and electrical load path.

20. The pantograph as recited in claim 17, wherein said collector comprises a pivot support suitable for allowing oscillation of said collector about said main axis of said travelling assembly.

21. The pantograph as recited in claim 17, wherein said collector comprises a cable connector suitable for routing current to a motor controller.

22. The pantograph as recited in claim 21, wherein said collector comprises a spindle suitable for providing at least one of a connection to said travelling assembly and a current path to said cable connector.

23. The pantograph as recited in claim 1, wherein said travelling assembly comprises a mast substantially defining the main axis of said travelling assembly.

24. The pantograph as recited in claim 23, wherein said mast comprises an extendable column suitable for at least one of supporting a collector and providing electrical isolation.

25. The pantograph as recited in claim 23, wherein said mast comprises a travelling sprocket suitable for lifting said mast thru tension in a lift chain.

26. The pantograph as recited in claim 23, wherein said mast comprises a chain connector suitable for providing a reaction point for a reaction force lowering said mast thru tension in a retraction chain.

27. The pantograph as recited in claim 1, further comprising a housing suitable for holding mechanisms of the pantograph.

28. The pantograph as recited in claim 27, wherein said housing further comprises bushings suitable for providing centric, linear guidance of said travelling assembly.

29. The pantograph as recited in claim 27, wherein said housing further comprises a substantially fixed guide pin suitable for engaging a corresponding groove provided substantially parallel to the main axis of said travelling assembly for anti-rotational guidance of said travelling assembly.

30. The pantograph as recited in claim 27, wherein said housing further comprises a guide way suitable for supporting members and centric guides for a counterweight.

31. The pantograph as recited in claim 27, wherein said housing further comprises a fixed sprocket suitable for supporting a counterweight through tension in a lift chain.

32. The pantograph as recited in claim 27, wherein said housing further comprises a release pin suitable for safety lock-out of engagement of said travelling assembly from the overhead conductor.

33. The pantograph as recited in claim 27, wherein said housing further comprises a chain deflector suitable for routing of a retraction chain.

34. The pantograph as recited in claim 1, further comprising a mounting base suitable for mounting the pantograph onto the vehicle.

35. The pantograph as recited in claim 34, wherein said mounting base comprises a rubber mount suitable for dynamic nulling.

36. The pantograph as recited in claim 34, wherein said mounting base comprises a cylinder mount suitable for providing a self-aligning interface.

37. The pantograph as recited in claim 34, wherein said mounting base comprises a retraction cylinder suitable for automatic lowering of said travelling assembly.

38. The pantograph as recited in claim 34, wherein said mounting base comprises an attachment point suitable for adjusting the location of the pantograph on the vehicle.

39. The pantograph as recited in claim 1, further comprising a retraction mechanism suitable for retracting said travelling mechanism away from the overhead conductor by overcoming the lift force.

40. The pantograph as recited in claim 39, wherein the pantograph operates in one of two modes: collector extension mode whereat the travelling assembly is biased towards engaging the overhead conductor; and collector retraction mode whereat the travelling assembly is biased away from engaging the overhead conductor.

41. The pantograph as recited in claim 39, wherein the retraction mechanism comprises manual displacement of the travelling mechanism suitable for a local operator to override the lift mechanism.

42. The pantograph as recited in claim 39, wherein the retraction mechanism comprises automatic displacement of the travelling mechanism suitable for a remote operator to override the lift mechanism.

43. A pantograph suitable for engaging an overhead conductor, the pantograph comprising:
(a) a support assembly;
(b) a collector assembly constrained to move in a substantially vertical fashion;
(c) a collector assembly lift mechanism coupling said support assembly to said collector assembly so that a substantially downward vertical force applied onto said collector assembly lift mechanism results in a substantially upwards vertical force being applied to said collector assembly causing said collector assembly to move in a substantially upwards direction relative to said support assembly; and
(d) a counterweight driving said collector assembly lift mechanism by gravity to bias said collector assembly in a substantially upwards direction towards the overhead conductor.

44. The pantograph as recited in claim 43, further comprising a collector assembly retraction mechanism coupling said support assembly to said collector assembly retraction mechanism so that a substantially downward vertical force applied onto said collector assembly retraction mechanism results in a substantially downward vertical force being applied to the collector assembly causing the collector assembly to move in a substantially downwards direction relative to said support assembly.

45. The pantograph as recited in claim 44, wherein the pantograph operates in one of two modes: collector extension mode whereat the collector assembly is biased to engage the overhead conductor; and collector retraction mode whereat the collector assembly is biased not to engage the overhead conductor.

46. A pantograph suitable for engaging an overhead conductor, the pantograph comprising:
(a) a support assembly;
(b) a collector assembly constrained to move in a substantially vertical fashion; and
(c) a counterweight driving said collector assembly by gravity to bias said collector assembly in a substantially upwards direction towards the overhead conductor;
whereby the collector assembly is subject to a substantially constant vertical force throughout the entire working travel of said collector assembly.

47. The pantograph as recited in claim 46, wherein the vertical velocity of the collector assembly is substantially constant.

48. The pantograph as recited in claim 47, wherein the vertical velocity of the collector assembly is substantially zero when the collector assembly engages the overhead conductor at a substantially constant nominal height above a roadbed.

49. The pantograph as recited in claim 46, wherein the vertical velocity of the collector assembly position constantly responds to a variation of the overhead conductor height from a constant nominal height above a roadbed by tracking the height of the overhead conductor so as to constantly engage the overhead conductor.

50. The pantograph as recited in claim 46, wherein force adjustment required for optimizing performance of the pantograph to dynamic conditions is applied in increments by adjusting the counterweight so as to provide a predictable response.

51. The pantograph as recited in claim 46, wherein there is no possibility of dynamic excitation of individual integrated components that would create force variability.

52. The pantograph as recited in claim 46, wherein the pantograph has low system hysteresis.

53. The pantograph as recited in claim 46, wherein the collector assembly comprises at least one brush, and wherein the collector assembly provides a reliable non-disruptive current path from the at least brush to a motor controller, thru the entire range of working travel of the collector assembly.

54. The pantograph as recited in claim 46, further comprising a housing, wherein the electrical separation of housing to collector assembly utilises an element of high dielectric strength.

55. The pantograph as recited in claim 46, wherein the pantograph requires little maintenance.

56. The pantograph as recited in claim 46, wherein counterweight provides a fail-safe ‘upward mode’.

57. The pantograph as recited in claim 46, wherein the vertical constrained movement minimizes mounting space requirements.
